(19) United States
(12) Patent Application Publication
(10) Pub. No.: US 2021/0254680 A1
(43) Pub. Date: Aug. 19, 2021

(54) DISK BRAKE

(71) Applicant: Hitachi Automotive Systems, Ltd., Ibaraki (JP)

(72) Inventor: Yusuke NISHINO, Minami Alps-shi, Yamanashi (JP)

(21) Appl. No.: 17/255,540

(22) PCT Filed: Jul. 18, 2019
(86) PCT No.: PCT/JP2019/028220

§ 371 Date: Dec. 23, 2020

(30) Foreign Application Priority Data
Jul. 23, 2018 (JP) 2018-137742

(51) Int. Cl. F16D 55/227; B60T 13/74; F16D 65/02; F16D 65/18

(52) U.S. Cl. CPC F16D 55/227; B60T 13/74; F16D 2121/24; F16D 65/18; F16D 65/02

(57) ABSTRACT

The present disk brake is configured in such a manner that a distance from a third straight line, which connects an intermediate point of a first straight line between first and second attachment holes and a center of a disk rotor D, to a first slide pin is longer than a distance from the above-described third straight line to a second slide pin. Due to this configuration, the disk brake can improve slidability between the first and second slide pins and first and second pin fitted insertion portions.

### TECHNICAL FIELD

The present invention relates to a disk brake used to brake a vehicle.

### BACKGROUND ART

Normally, a disk brake employed for an automobile or the like includes a pair of inner and outer friction pads, a caliper, and a mount member. The inner friction pad and the outer friction pad are disposed on the both sides of a disk rotor attached to a rotatable portion of the vehicle, respectively. The caliper presses these inner and outer friction pads against the disk rotor. The mount member is fixed to a non-rotatable portion such as a knuckle of the vehicle via two attachment holes. This mount member supports each of the pair of inner and outer friction pads and the caliper movably in a disk axial direction. More specifically, slide pins are fixed to a pair of arm portions of the caliper, respectively, and this pair of slide pins is slidably inserted through a pair of pin fitted insertion portions of the mount member, by which the caliper is supported by the mount member movably in the disk axial direction (refer to PTL 1).

### CITATION LIST

### Patent Literature

PTL 1: Japanese Patent Application Public Disclosure No. 2013-113378

### SUMMARY OF INVENTION

### Technical Problem

In the invention discussed in the above-described patent literature, PTL 1, an intermediate point between the pair of pin fitted insertion portions of the mount member is located at generally the same position in the circumferential direction of the disk rotor as the central axis of a cylinder portion of the caliper, in which a piston is axially movably supported. However, actually, the center of gravity of the caliper including an electric motor and the like is offset toward one pin fitted insertion portion side, and therefore sliding resistance may increase between the slide pins and the pin fitted insertion portions.

### Solution to Problem

Under these circumstances, an object of the present invention is to provide a disk brake capable of improving slidability between slide pins of a caliper and pin fitted insertion portions of a mount member.

To achieve the above-described object, according to one aspect of the present invention, a first disk brake includes a mount member attached to a non-rotatable portion of a vehicle so as to extend across over a disk rotor via two attachment portions and including a pair of pin fitted insertion portions extending in an axial direction of the disk rotor, a caliper supported slidably along the axial direction of the disk rotor relative to the mount member via first and second slide pins slidably fitted in the pair of pin fitted insertion portions, respectively, and at least one pair of friction pads attached movably in the axial direction of the disk rotor relative to the mount member at positions on both surface sides of the disk rotor. The at least one pair of friction pads is configured to press both surfaces of the disk rotor by the caliper. A piston configured to press any one of the friction pads is contained in the caliper so as to be able to protrude, and the caliper includes a bottomed cylindrical cylinder portion and a driving portion. The cylinder portion contains a piston thrust mechanism configured to thrust the piston. The driving portion is supported on a bottom portion side of the cylinder portion so as to apply a thrust force to the piston thrust mechanism. The first slide pin is disposed on a closer side to a center of gravity of the driving portion than the second slide pin is in a direction along a first straight line connecting centers of the two attachment portions. A distance from a straight line connecting an intermediate point of the first straight line and a center of the disk rotor to the first slide pin is longer than a distance from the straight line connecting the intermediate point of the first straight line and the center of the disk rotor to the second slide pin.

Further, according to one aspect of the present invention, a second disk brake includes a mount member supporting at least one pair of friction pads positioned on both surface sides of a disk rotor and fixed to a non-rotatable portion of a vehicle via two attachment portions, and a caliper including a pair of slide pins slidably supported in a pair of pin fitted insertion portions, respectively. The pin fitted insertion portions are disposed on an outer side in a radial direction of the disk rotor with respect to the two attachment portions of the mount member. The caliper is configured to press the friction pad by a pressing member contained inside the caliper. The disk brake further includes an electric motor configured to transmit a thrust force to a thrust mechanism configured to move the pressing member. The electric motor is provided in the caliper so as to be arranged side by side with the pressing member in a circumferential direction of the disk rotor. The pair of slide pins is disposed in the caliper in such a manner that an intermediate point of a second straight line connecting central axes of this pair of slide pins is located on the electric motor side in the circumferential direction of the disk rotor with respect to an intermediate point of a first straight line connecting centers of the two attachment portions.

### Advantageous Effects of Invention

The disk brake according to each of the one aspects of the present invention can improve the slidability between the slide pins of the caliper and the pin fitted insertion portions of the mount member.

### BRIEF DESCRIPTION OF DRAWINGS

FIG. 1 is a schematic perspective view of an outer appearance of a disk brake according to an embodiment of the present invention.

FIG. 2 is a plan view of the disk brake according to the present embodiment as viewed from a vehicle inner side (an inner side).

FIG. 3 is a plan view of the disk brake according to the present embodiment as viewed from a vehicle longitudinal direction.

FIG. 4 is a schematic view illustrating a caliper in the disk brake according to the present embodiment.

### DESCRIPTION OF EMBODIMENTS

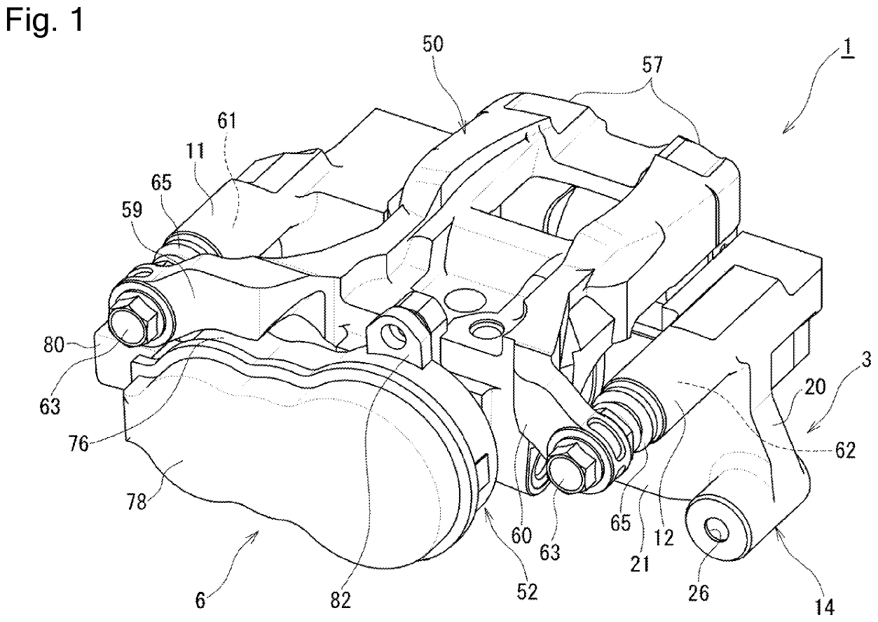

A disk brake 1 according to an embodiment of the present invention will be described in detail with reference to FIGS. 1 to 4. In the following description, the disk brake 1 will be described, referring to the wheel side of the disk rotor D as an outer side, and referring to the central portion side in the lateral direction of the vehicle, which corresponds to the opposite side of the disk rotor D from the wheel, as an inner side. Further, the disk brake 1 will be described, referring to the axial direction of the disk rotor D as a disk axial direction, referring to the radial direction of the disk rotor D as a disk radial direction, and referring to the circumferential direction of the disk rotor D as a disk circumferential direction.

As illustrated in FIGS. 1 to 3, the disk brake 1 according to the present embodiment is formed by a floating caliper-type disk brake. The present disk brake 1 includes a disk rotor D, a mount member 3, a pair of inner and outer friction pads 4 and 5, and a caliper 6. The disk rotor D rotates together with the wheel. The mount member 3 is disposed so as to extend across over the disk rotor D, and is fixed to a non-rotatable portion (not illustrated) on the vehicle body side. The pair of inner and outer friction pads 4 and 5 is disposed on the both sides of the disk rotor D, and is supported by the mount member 3. The caliper 6 is disposed so as to extend across over the disk rotor D, and is supported movably along the disk axial direction relative to the mount member 3 via a pair of first and second slide pins 61 and 62.

First, the mount member 3 will be described in detail with reference to FIGS. 1 to 3. This mount member 3 includes a pair of first and second pin fitted insertion portions 11 and 12, and inner-side and outer-side support portions 14 and 15. First and second slide pins 61 and 62 of a caliper main body 50, which will be described below, are inserted through the pair of first and second pin fitted insertion portions 11 and 12, respectively. The inner-side and outer-side support portions 14 and 15 are integrally connected to these first and second pin fitted insertion portions 11 and 12, and support the inner and outer friction pads 4 and 5 independently of each other, respectively. The first and second pin fitted insertion portions 11 and 12 are arranged at an interval along the disk circumferential direction, and both the first and second pin fitted insertion portions 11 and 12 each extend along the disk axial direction.

The first and second pin fitted insertion portions 11 and 12 are formed into bottomed cylindrical shapes including pin holes 17 and 17, in which the first and second slide pins 61 and 62 are inserted through, respectively. The opening sides and bottom portion sides of the pin holes 17 and 17 of the first and second pin fitted insertion portions 11 and 12 face the inner side and the outer side, respectively. The outer-side support portion 15 is integrally connected to the outer sides of the first and second pin fitted insertion portions 11 and 12. The inner-side support portion 14 is integrally connected to portions of the first and second pin fitted insertion portions 11 and 12 that are spaced apart from the outer-side support portion 15 to the inner side along the disk axial direction.

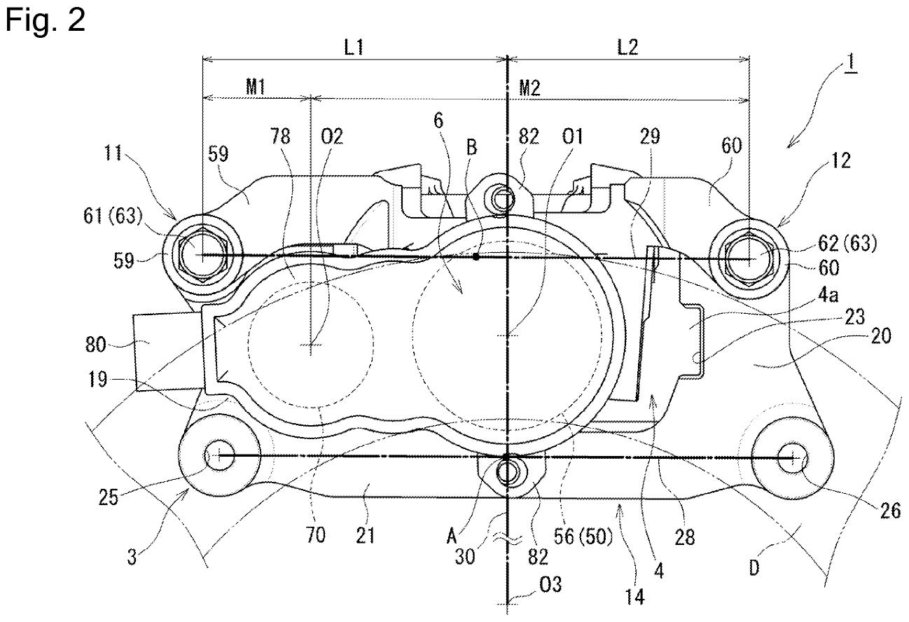

The inner-side support portion 14 includes a pair of inner-side arm portions 19 and 20 and an inner-side beam portion 21. The inner-side arm portions 19 and 20 have one end portions integrally connected to the first and second pin fitted insertion portions 11 and 12, respectively. The inner-side beam portion 21 integrally connects the other end portions of this pair of inner-side arm portions 19 and 20 to each other. Each of the inner-side arm portions 19 and 20 bears a braking torque transmitted from the inner friction pad 4 when the vehicle is braked while running forward or backward. Support recessed portions 23 and 23 are formed on facing surfaces of these inner-side arm portions 19 and 20, respectively. These support recessed portions 23 and 23 are each formed into a generally squared U-like shape (or an open sided rectangle-shaped sectional configuration) in cross section. Then, as illustrated in FIG. 2, the inner friction pad 4 includes engagement portions 4a and 4a protruding from the both side portions thereof, respectively. The engagement portions 4a and 4a are engaged with the support recessed portions 23 and 23 of the respective inner-side arm portions, and are supported movably in directions toward and away from the disk rotor D.

First and second attachment holes 25 and 26 are formed at generally both end portions of the inner-side beam portion 21 in the disk circumferential direction. The first and second attachment holes 25 and 26 are used to attach the mount member 3 to the non-rotatable portion of the vehicle, and extend through the inner-side beam portion 21 along the disk axial direction. The first and second attachment holes 25 and 26 correspond to two attachment portions. Then, the pair of first and second pin fitted insertion portions 11 and 12 are located on the outer side in the radial direction of the disk rotor D with respect to the pair of first and second attachment holes 25 and 26. In a plan view illustrated in FIG. 2, a first straight line 28 and a second straight line 29 extend in parallel with each other. The first straight line 28 connects the radial center of the first attachment hole 25 and the radial center of the second attachment hole 26 of the inner-side support portion 14 (hereinafter referred to as the first straight line 28). The second straight line 29 connects the central axis of the first pin fitted insertion portion 11 (the first slide pin 61) and the central axis of the second pin fitted insertion portion 12 (the second slide pin 62) (hereinafter referred to as the second straight line 29). An intermediate point A of the first straight line 28 between the first and second attachment holes 25 and 26 is located at generally the same position as the central position of the inner-side beam portion 21 in the longitudinal direction thereof. Further, the intermediate point A of the first straight line 28 between the first attachment holes 25 and 26 is located at generally the same position as a radial center O1 of a cylinder portion 56 of the caliper main body 50, which will be described below, in a direction of the first and second straight lines 28 and 29 (generally the disk circumferential direction).

Further, in the plan view illustrated in FIG. 2, the first pin fitted insertion portion 11 (the first slide pin 61) is located on a closer side to a center of gravity O2 of an electric motor 70, which will be described below, than the position of the second pin fitted insertion portion 12 (the second slide pin 62) is (a distance M1<a distance M2) in the direction along the first and second straight lines 28 and 29 (generally the disk circumferential direction). In other words, in the plan view illustrated in FIG. 2, the electric motor 70 is disposed closer to the first pin fitted insertion portion 11 (the first slide pin 61) than to the second pin fitted insertion portion 12 (the second slide pin 62) in the direction of the first and second straight lines 28 and 29 (generally the disk circumferential direction). An intermediate point B of the second straight line 29 between the first and second pin fitted insertion portions 11 and 12 (the first and second slide pins 61 and 62) is located closer to the first pin fitted insertion portion 11 than the radial center O1 of the cylinder portion 56 of the caliper main body 50, which will be described below, i.e., the intermediate point A of the first straight line 28 between the first and second attachment holes 25 and 26 is in the direction of the first and second straight lines 28 and 29 (generally the disk circumferential direction). Then, a distance L1 is set to longer than a distance L2. The distance L1 is a distance from a third straight line 30, which connects the intermediate point A of the first straight line 28 between the first and second attachment holes 25 and 26 and a center O3 of the disk rotor D, to the central axis of the first pin fitted insertion portion 11 (the first slide pin 61). The distance L2 is a distance from the above-described third straight line 30 to the central axis of the second pin fitted insertion portion 12 (the second slide pin 62).

The outer-side support portion 15 includes a pair of outer-side arm portions 32 and 33 and an outer-side beam portion 34. The outer-side arm portions 32 and 33 have one end portions integrally connected to the first and second pin fitted insertion portions 11 and 12, respectively. The outer-side beam portion 34 integrally connects the other end portions of this pair of outer-side arm portions 32 and 33 to each other. Each of the outer-side arm portions 32 and 33 bears a braking torque transmitted from the outer friction pad 5 when the vehicle is braked while running forward or backward. Support recessed portions (not illustrated) are formed on facing surfaces of these outer-side arm portions 32 and 33, respectively. The support recessed portions are each formed into a generally squared U-like shape in cross section. Then, the outer friction pad 5 includes engagement portions (not illustrated) protruding from the both side portions thereof, respectively. The engagement portions are engaged with the support recessed portions of the respective inner-side arm portions 32 and 33, and are supported movably in the directions toward and away from the disk rotor D. The pair of inner-side arm portions 19 and 20 of the inner-side support portion 14 is formed so as to be longer than the pair of outer-side arm portions 32 and 33 of the outer-side support portion 15. As a result, the inner-side beam portion 21 of the inner-side support portion 14 is disposed on the radially inner side of the disk rotor D with respect to the outer-side beam portion 34 of the outer-side support portion 15. Then, the disk rotor D is disposed at a portion of the mount member 3 between the inner-side support portion 14 and the outer-side support portion 15, i.e., between the inner-side friction pad 4 supported on the inner-side support portion 14 movably in the disk axial direction, and the outer friction pad 5 supported on the outer-side support portion 15 movably in the disk axial direction.

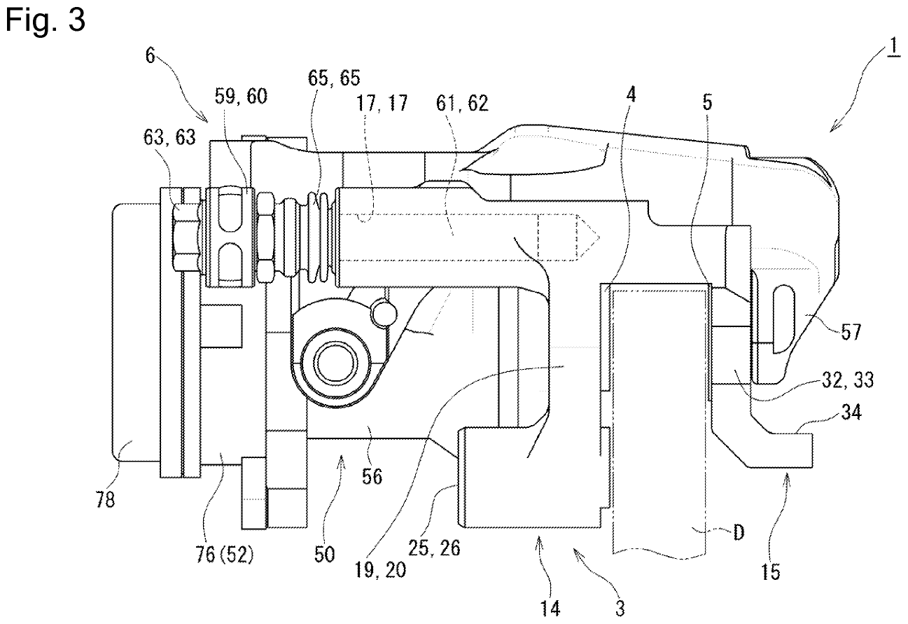

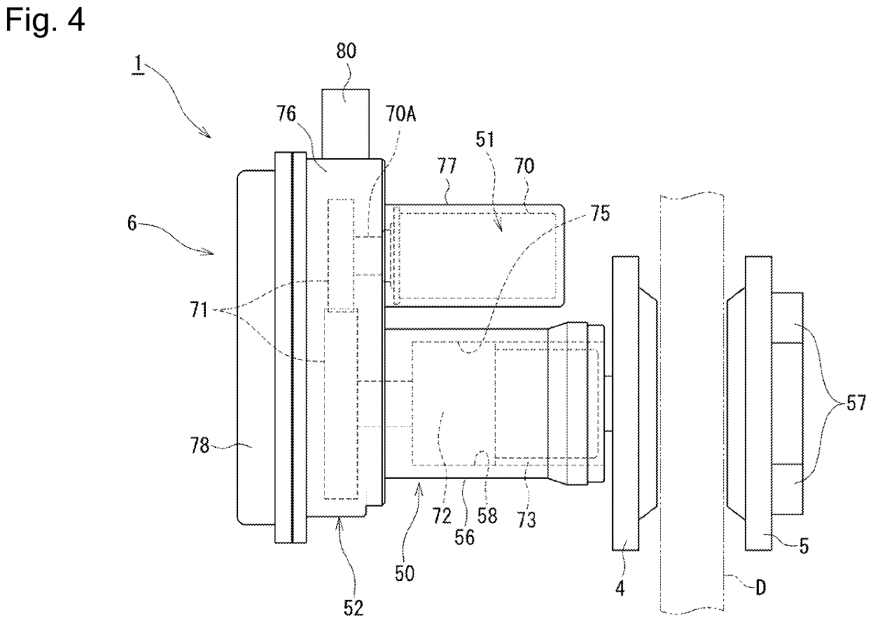

Next, the caliper 6 will be described with reference to FIG. 4, and also with reference to FIGS. 2 and 3 when necessary.

The caliper 6 integrally includes the caliper main body 50, a driving unit 51, and a housing 52 containing a part of this driving unit 51. The caliper main body 50 integrally includes the cylindrical cylinder portion 56, a claw portion 57, and a pair of first and second caliper arm portions 59 and 60. The cylinder portion 56 is opened to the inner friction pad 4. The claw portion 57 extends from the cylinder portion 56 to the opposite side across over the disk rotor D, and is attached in abutment with the outer friction pad 5. The pair of first and second caliper arm portions 59 and 60 extends from the cylinder portion 56 outward.

A guide bore 58 is formed in the cylinder portion 56. A piston 73 of the driving unit 51 is slidably fitted in the guide bore 58. As illustrated in FIGS. 2 and 3, the first and second slide pins 61 and 62 are fixed to the distal end portions of the first and second caliper arm portions 59 and 60 with use of attachment bolts 63 and 63, respectively. As described above, these first and second slide pins 61 and 62 are inserted through the pin holes 17 and 17 of the first and second pin fitted insertion portions 11 and 12 of the mount member 3 slidably in the axial direction of the pin holes 17 and 17. Pin boots 65 and 65 made from rubber are provided between one end portions of the first and second slide pins 61 and 62 and the first and second pin fitted insertion portions 11 and 12 of the mount member 3. The pin boots 65 and 65 include extensible/compressible bellows portions covering the first and second slide pins 61 and 62, respectively.

The driving mechanism 51 includes the electric motor 70, a speed reduction mechanism 71, a piston thrust mechanism 72, and the piston 73. The electric motor 70 serves as a driving portion. The speed reduction mechanism 71 powers up a rotational force output from this electric motor 70. The piston thrust mechanism 72 converts the rotational motion from this speed reduction mechanism 71 into a linear motion to apply a thrust force to the piston 73. The piston 73 presses the inner friction pad 4 by receiving the thrust force from this piston thrust mechanism 72. The piston 73 corresponds to a pressing member. The electric motor 70 is disposed so as to be arranged side by side with the cylinder portion 56 (the piston 73) of the caliper main body 50 along the disk circumferential direction. A rotational shaft 70A of the electric motor 70 protrudes into a first housing portion 76 of the housing 52.

The speed reduction mechanism 71 functions to power up the rotational force output from the electric motor 70 and transmit it to the piston thrust mechanism 72. The speed reduction mechanism 71 is contained in the first housing 76 of the housing 52. For example, a planetary gear speed reduction mechanism is employed as the speed reduction mechanism 71. The piston 73 is formed into a bottomed cylindrical shape. The piston 73 is supported movably along the axial direction in the guide bore 58 of the cylinder portion 56. The inner friction pad 4 is located at a position facing the bottom portion of the piston 73 in a state held by the inner-side support portion 14 of the mount member 3. A space in the cylinder portion 56 between the bottom portion of this cylinder portion 56 and the bottom portion of the piston 73 is defined as a hydraulic pressure chamber 75, into which a brake hydraulic pressure is supplied from a master cylinder via a hydraulic pressure circuit (both are not illustrated). The piston thrust mechanism 72 is formed by a rotation-linear motion conversion mechanism that converts the rotational motion output from the speed reduction mechanism 71 into the linear motion to apply the thrust force to the piston 73 and also holds the piston 73 at the braking position. This piston thrust mechanism 72 is contained between the bottom portion of the cylinder portion 56 and the bottom portion of the piston 73. For example, a screw mechanism, a ball screw mechanism, a ball and ramp mechanism, and the like are employed alone or in combination as necessary as the piston thrust mechanism 72.

The housing 52 includes the first housing portion 76 and a second housing portion 77. The first housing portion 76 contains the speed reduction mechanism 71 while extending so as to cover the outer periphery of the bottom portion of the cylinder portion 56. The second housing portion 77 is provided in a protruding manner so as to have a bottomed cylindrical shape extending integrally from near the end portion of the first housing 76 in the longitudinal direction thereof toward the disk rotor D side. An opening of the housing 52 (the first housing portion 76) on one side is air-tightly closed by a cover 78. In the shape as viewed in the plan view illustrated in FIG. 2, the first housing portion 76 (the cover 78) is formed in such a manner that the longitudinal direction thereof extends generally along the disk circumferential direction, and the end portion thereof in the longitudinal direction is located between the first pin fitted insertion portion 11 and the first attachment hole 25 of the inner-side support portion 14. Then, the second housing portion 77 is integrally formed on the first pin fitted insertion portion 11 side in the longitudinal direction of the first housing 76. The electric motor 70 is contained in this second housing portion 77.

The first housing portion 76 is formed in such a manner that the outer peripheral end portion in the longitudinal direction thereof on one side where the cylinder portion 56 is fixed is shaped like a large circular arc, and the outer peripheral end portion in the longitudinal direction thereof on the other side where the second housing portion 77 (the electric motor 70) is located is shaped like a small circular arc. Then, in the plan view illustrated in FIG. 2, the center of gravity O2 of the electric motor 70 in the second housing portion 77 is positioned between the first straight line 28 and the second straight line 29. Further, the electric motor 70 is arranged in such a manner that the center of gravity O2 thereof is located at a position closer to the intermediate point B of the second straight line 29 than to the intermediate point A of the first straight line 28 in the direction of the first and second straight lines 28 and 29 (generally the disk circumferential direction). In other words, the intermediate point B of the second straight line 29 is located closer to the center of gravity O2 of the electric motor 70 than the radial center O1 of the cylinder portion 56 of the caliper main body 50, i.e., the intermediate point A of the first straight line 28 between the first and second attachment holes 25 and 26 is in the direction of the first and second straight lines 28 and 29 (generally the disk circumferential direction).

A connector portion 80 is integrally provided in a protruding manner at the end portion of the first housing portion 76 on the first pin fitted insertion portion 11 side in the longitudinal direction thereof. In the plan view illustrated in FIG. 2, this connector portion 80 is provided in a protruding manner from a portion of the mount member 3 between the first pin fitted insertion portion 11 and the first attachment hole 25 of the inner-side support portion 14 outward. Then, in the plan view illustrated in FIG. 2, the distal end portion of the first caliper arm portion 59, i.e., the radially outer peripheral portion of the first slide pin 61 is located on the outer side in the radial direction of the disk rotor D with respect to the outer peripheral wall of the connector portion 80. In other words, the position of the outer wall portion of the first slide pin 61 that is separated farthest away from the center O3 of the disk rotor D is located on the outer side in the radial direction of the disk rotor D with respect to the position of the outer wall portion of the connector portion 80 that is separated farthest away from the center O3 of the disk rotor D. A control board (not illustrated) electrically connected to the electric motor 70 is disposed in the first housing portion 76. This control board is electrically connected to the connector portion 80. Due to this configuration, the electric motor 70 is electrically connected to the connector 80 via the control board.

Then, as illustrated in FIGS. 1 and 2, the housing 52 is fixed to the cylinder portion 56 of the caliper main body 50 via a plurality of fixation portions 82 provided in protruding manners from the outer peripheral portion of the first housing portion 76 outward. The caliper 6 is formed by fixing the housing 52 to the cylinder portion 56 of the caliper main body 50 via each of the fixation portions 82 in this manner.

Next, the functions of the disk brake 1 according to the present embodiment will be described.

First, the function when the disk brake 1 brakes the vehicle as a normal hydraulic brake according to an operation performed on a brake pedal (not illustrated) will be described.

When the brake pedal is pressed by a driver, a brake hydraulic pressure according to a force pressing the brake pedal is supplied from the master cylinder into the hydraulic pressure chamber 75 in the cylinder portion 56 of the caliper main body 50 via the hydraulic pressure circuit. As a result, the piston 73 advances (moves rightward in FIG. 3) from the original position, at which the piston 73 has been located when the vehicle has not been braked, while elastically deforming a piston seal (not illustrated), and presses the inner friction pad 4 against the disk rotor D. Then, the caliper main body 50 moves leftward in FIG. 3 relative to the mount member 3 due to a reaction force of the pressing force of the piston 73, and presses the outer friction pad 5 attached to the claw portion 57 against the disk rotor D. As a result, the disk rotor D is sandwiched by the pair of inner and outer brake pads 4 and 5 and a frictional force is generated thereon, and thus the braking force is generated on the vehicle.

After that, when the driver releases the brake pedal, the supply of the hydraulic pressure from the master cylinder is stopped, and therefore the hydraulic pressure in the hydraulic pressure chamber reduces. As a result, the piston 73 is retracted to the original position due to a resilience force of the piston seal from the elastic deformation, and therefore the braking force is released.

Further, when a parking brake, which is one example of the function for keeping the vehicle in a stopped state, is actuated, the electric motor 70 is driven and the rotational force thereof is transmitted to the piston thrust mechanism 72 via the speed reduction mechanism 71 of the driving unit 51 and is converted into the linear motion of the piston 73. Then, the piston 73 advances, and the disk rotor D is sandwiched by the inner and outer friction pads 4 and 5 and thus the braking force is generated. Then, the piston 73 is kept at the braking position due to the piston thrust mechanism 72. As a result, the braking force is maintained, and the actuation of the parking brake is completed.

After that, when the parking brake is released, the electric motor 70 is rotationally driven in a release direction for separating the piston 73 away from the disk rotor D. As a result, the speed reduction mechanism 71 is rotationally driven in a release direction for returning the piston 73 and the piston 73 is retracted to the original position due to the resilience force of the piston seal from the elastic deformation, and therefore the braking force is completely released.

In the above-described manner, the disk brake 1 according to the present embodiment is configured in such a manner that the first slide pin 61 is disposed on the closer side to the center of gravity O2 of the electric motor 70 than the second slide pin 62 is (the distance M1<the distance M2) in the direction along the first straight line 28 connecting the radial centers of the first and second attachment holes 25 and 26 of the inner-side support portion 14, and the distance L1 from the third straight line 30, which connects the intermediate point A of the first straight line 28 between the first and second attachment holes 25 and 26 and the center O3 of the disk rotor D, to the first slide pin 61 is longer than the distance L2 from the above-described third straight line 30 to the second slide pin 62. Due to this configuration, the disk brake 1 allows the positions of the first and second pin fitted insertion portions 11 and 12 (the first and second slide pins 61 and 62) to be set as appropriate based on the position of the center of gravity of the caliper 6 including the electric motor 70 and the like, thereby being able to improve the slidability between the first and second slide pins 61 and 62 and the first and second pin fitted insertion portions 11 and 12.

Further, in the disk brake 1 according to the present embodiment, the electric motor 70 has the center of gravity O2 at the position closer to the intermediate point B of the second straight line 29 between the first and second slide pins 61 and 62 than to the intermediate point A of the first straight line 28 between the first and second attachment holes 25 and 26. Due to this configuration, the disk rotor 1 can further improve the slidability between the first and second slide pins 61 and 62 and the first and second pin fitted insertion portions 11 and 12.

Further, in the disk brake 1 according to the present embodiment, the radially outer peripheral portion of the first slide pin 61 is located on the outer side in the radial direction of the disk rotor D with respect to the connector portion 80. Due to this configuration, the disk brake 1 can protect the connector portion 80 from, for example, snow attached on the inner surface of the wheel (not illustrated).

Furthermore, in the disk brake 1 according to the present embodiment, the electric motor 70 has the center of gravity O2 at the position between the first straight line 28 between the first and second attachment holes 25 and 26, and the second straight line 29 between the first and second slide pins 61 and 62. Due to this configuration, the disk brake 1 can improve the slidability between the first and second slide pins 61 and 62 and the first and second pin fitted insertion portions 11 and 12, and, moreover, can protect the electric motor 70 and the speed reduction mechanism 71 from, for example, the snow attached on the inner surface of the wheel.

Furthermore, in the disk brake 1 according to the present embodiment, the first and second slide pins 61 and 62 are each arranged in the caliper 6 in such a manner that the intermediate point B of the second straight line 29 between these first and second slide pins 61 and 62 is located on the electric motor 70 side with respect to the intermediate point A of the first straight line 29 between the first and second attachment holes 25 and 26 in the direction of the first and second straight lines 28 and 29 (generally the disk circumferential direction). Due to this configuration, the disk brake 1 can improve the slidability between the first and second slide pins 61 and 62 and the first and second pin fitted insertion portions 11 and 12.

The above-described embodiment may be employed for an electric disk brake that drives the electric motor 70 to generate the braking force at the time of normal braking.

Possible configurations as the disk brake 1 based on the above-described embodiment include the following examples.

According to a first configuration, the disk brake 1 includes the mount member 3 attached to the non-rotatable portion of the vehicle so as to extend across over the disk rotor D via the two attachment portions (25 and 26) and including the pair of pin fitted insertion portions 11 and 12 extending in the axial direction of the disk rotor D, the caliper 6 supported slidably along the axial direction of the disk rotor D relative to the mount member 3 via the first and second slide pins 61 and 62 slidably fitted in the pair of pin fitted insertion portions 11 and 12, respectively, and the at least one pair of friction pads 4 and 5 attached movably in the axial direction of the disk rotor D relative to the mount member 3 at the positions on the both surface sides of the disk rotor D. The at least one pair of friction pads 4 and 5 is configured to press the both surfaces of the disk rotor D by the caliper 6. The piston 73 configured to press any one of the friction pads 4 and 5 is contained in the caliper 6 so as to be able to protrude, and the caliper 6 includes the bottomed cylindrical cylinder portion 56 and the driving portion (70). The cylinder portion 56 contains the piston thrust mechanism 72 configured to thrust the piston 73. The driving portion (70) is supported on the bottom portion side of the cylinder portion 56 so as to apply the thrust force to the piston thrust mechanism 72. The first slide pin 61 is disposed on the closer side to the center of gravity O2 of the driving portion 70 than the second slide pin 62 is in the direction along the first straight line 28 connecting the centers of the two attachment portions (25 and 26). The distance L1 from the straight line 30 connecting the intermediate point A of the first straight line 28 and the center O3 of the disk rotor D to the first slide pin 61 is longer than the distance L2 from the straight line 30 connecting the intermediate point A of the first straight line 28 and the center O3 of the disk rotor D to the second slide pin 62.

According to a second configuration, in the first configuration, the driving portion (70) has the center of gravity O2 at the position closer to the intermediate point B of the second straight line 29 connecting the central axis of the first slide pin 61 and the central axis of the second slide pin 62 than to the intermediate point A of the first straight line 28.

According to a third configuration, in the first or second configuration, the driving portion (70) includes the connector portion 80 at the end portion thereof on the closer side to the first slide pin 61 in the circumferential direction of the disk rotor D. The radially outer peripheral portion of the first slide pin 61 is located on the outer side in the radial direction of the disk rotor D with respect to the outer peripheral wall of the connector portion 80.

According to a fourth configuration, in any of the first to third configurations, the driving portion (70) has the center of gravity O2 at the position between the first straight line 28 connecting the centers of the two attachment portions (25 and 26) and the second straight line 29 connecting the central axis of the first slide pin 61 and the central axis of the second slide pin 62.

According to a fifth configuration, the disk brake D includes the mount member 3 supporting the at least one pair of friction pads 4 and 5 positioned on the both surface sides of the disk rotor D and fixed to the non-rotatable portion of the vehicle via the two attachment portions (25 and 26), and the caliper 6 including the pair of slide pins 61 and 62 slidably supported in the pair of pin fitted insertion portions 11 and 12, respectively. The pin fitted insertion portions 11 and 12 are disposed on the outer side in the radial direction of the disk rotor D with respect to the two attachment portions (25 and 26) of the mount member 3. The caliper 6 is configured to press the friction pad 4 by the pressing member (73) contained inside the caliper 6. The disk brake 1 further includes the electric motor 70 configured to transmit the thrust force to the thrust mechanism 72 configured to move the pressing member (73). The electric motor 70 is provided in the caliper 6 so as to be arranged side by side with the pressing member (73) in the circumferential direction of the disk rotor D. The pair of slide pins 61 and 62 is disposed in the caliper 6 in such a manner that the intermediate point B of the second straight line 29 connecting the central axes of this pair of slide pins 61 and 62 is located on the electric motor 70 side in the circumferential direction of the disk rotor D with respect to the intermediate point A of the first straight line 28 connecting the centers of the two attachment portions (25 and 26).

The present invention shall not be limited to the above-described embodiments, and includes various modifications. For example, the above-described embodiments have been described in detail to facilitate a better understanding of the present invention, and the present invention shall not necessarily be limited to the configuration including all of the described features. Further, a part of the configuration of some embodiment can be replaced with the configuration of another embodiment. Further, some embodiment can also be implemented with a configuration of another embodiment added to the configuration of this embodiment. Further, each of the embodiments can also be implemented with another configuration added, deleted, or replaced with respect to a part of the configuration of this embodiment.

The present application claims priority under the Paris Convention to Japanese Patent Application No. 2018-137742 filed on Jul. 23, 2018. The entire disclosure of Japanese Patent Application No. 2018-137742 filed on Jul. 23, 2018 including the specification, the claims, the drawings, and the abstract is incorporated herein by reference in its entirety.

### REFERENCE SIGNS LIST

1 disk brake

3 mount member

4 inner friction pad

5 outer friction pad

6 caliper

50 caliper main body

51 driving unit

11 first pin fitted insertion portion

12 second pin fitted insertion portion

25 first attachment hole (attachment portion)

26 second attachment hole (attachment portion)

28 first straight line

29 second straight line

30 third straight line

56 cylinder portion

61 first slide pine

62 second slide pin

70 electric motor (driving portion)

72 piston thrust mechanism (thrust mechanism)

73 piston (pressing member)

80 connector portion (driving portion)

A intermediate point

B intermediate point

D disk rotor

1. A disk brake comprising:
a mount member attached to a non-rotatable portion of a vehicle so as to extend across over a disk rotor via two attachment portions, the mount member including a pair of pin fitted insertion portions extending in an axial direction of the disk rotor;
a caliper supported slidably along the axial direction of the disk rotor relative to the mount member via first and second slide pins slidably fitted in the pair of pin fitted insertion portions, respectively; and
at least one pair of friction pads attached movably in the axial direction of the disk rotor relative to the mount member at positions on both surface sides of the disk rotor, the at least one pair of friction pads being configured to press both surfaces of the disk rotor by the caliper,
wherein a piston configured to press any one of the friction pads is contained in the caliper so as to be able to protrude, and the caliper includes a bottomed cylindrical cylinder portion and a driving portion, the cylinder portion containing a piston thrust mechanism configured to thrust the piston, the driving portion being supported on a bottom portion side of the cylinder portion so as to apply a thrust force to the piston thrust mechanism,
wherein the first slide pin is disposed on a closer side to a center of gravity of the driving portion than the second slide pin is in a direction along a first straight line connecting centers of the two attachment portions, and
wherein a distance from a straight line connecting an intermediate point of the first straight line and a center of the disk rotor to the first slide pin is longer than a distance from the straight line connecting the intermediate point of the first straight line and the center of the disk rotor to the second slide pin.

2. The disk brake according to claim 1, wherein the driving portion has the center of gravity at a position closer to an intermediate point of a second straight line connecting a central axis of the first slide pin and a central axis of the second slide pin than to the intermediate point of the first straight line.

3. The disk brake according to claim 1, wherein the driving portion includes a connector portion at an end portion thereof on a closer side to the first slide pin in a circumferential direction of the disk rotor, and
wherein a radially outer peripheral portion of the first slide pin is located on an outer side in a radial direction of the disk rotor with respect to an outer peripheral wall of the connector portion.

4. The disk brake according to claim 1, wherein the driving portion has the center of gravity at a position between the first straight line connecting the centers of the two attachment portions and the second straight line connecting the central axis of the first slide pin and the central axis of the second slide pin.

5. A disk brake comprising:
a mount member supporting at least one pair of friction pads positioned on both surface sides of a disk rotor, the mount member being fixed to a non-rotatable portion of a vehicle via two attachment portions;
a caliper including a pair of slide pins slidably supported in a pair of pin fitted insertion portions, respectively, the pin fitted insertion portions being disposed on an outer side in a radial direction of the disk rotor with respect to the two attachment portions of the mount member, the caliper being configured to press the friction pad by a pressing member contained inside the caliper; and
an electric motor configured to transmit a thrust force to a thrust mechanism configured to move the pressing member, the electric motor being provided in the caliper so as to be arranged side by side with the pressing member in a circumferential direction of the disk rotor,
wherein the pair of slide pins is disposed in the caliper in such a manner that an intermediate point of a second straight line connecting central axes of the pair of slide pins is located on the electric motor side in the circumferential direction of the disk rotor with respect to an intermediate point of a first straight line connecting centers of the two attachment portions.

6. The disk brake according to claim 2, wherein the driving portion includes a connector portion at an end portion thereof on a closer side to the first slide pin in a circumferential direction of the disk rotor, and
wherein a radially outer peripheral portion of the first slide pin is located on an outer side in a radial direction of the disk rotor with respect to an outer peripheral wall of the connector portion.

7. The disk brake according to claim 2, wherein the driving portion has the center of gravity at a position between the first straight line connecting the centers of the two attachment portions and the second straight line connecting the central axis of the first slide pin and the central axis of the second slide pin.

8. The disk brake according to claim 3, wherein the driving portion has the center of gravity at a position between the first straight line connecting the centers of the two attachment portions and the second straight line connecting the central axis of the first slide pin and the central axis of the second slide pin.

9. The disk brake according to claim 6, wherein the driving portion has the center of gravity at a position between the first straight line connecting the centers of the two attachment portions and the second straight line connecting the central axis of the first slide pin and the central axis of the second slide pin.
